(19) United States
(12) Patent Application Publication
(10) Pub. No.: US 2026/0171877 A1
(43) Pub. Date: Jun. 18, 2026

(54) PHOTONICALLY POWERED ELECTROMAGNETIC GENERATOR

(71) Applicant: Board of Trustees of Michigan State University, East Lansing, MI (US)

(72) Inventors: Woongkul LEE, West Lafayette, IN (US); Kangbeen LEE, Lafayette, IN (US); Ryan Daniel ATKINSON, Dundee, MI (US); Gavin Thomas GARDNER, Milford, MI (US)

(73) Assignee: Board of Trustees of Michigan State University, East Lansing, MI (US)

(21) Appl. No.: 19/535,331

(22) Filed: Feb. 10, 2026

Related U.S. Application Data
(63) Continuation of application No. PCT/US2024/047630, filed on Sep. 20, 2024.
(60) Provisional application No. 63/540,154, filed on Sep. 25, 2023.

(51) Int. Cl. H02K 11/00; H02K 1/12; H02K 1/22; H02S 20/30

(52) U.S. Cl. CPC H02K 11/0094; H02S 20/30; H02K 1/12; H02K 1/22

(57) ABSTRACT

A photonically powered electromagnetic generator is provided. In another aspect, a generator includes a photon source configured to emit photons, a photovoltaic cell configured to receive the photons, a rotor including a yoke and wire windings, a stator surrounding the rotor, and the rotor being configured to create electromagnetism due to its receipt of electricity from the photovoltaic cell when the photovoltaic cell receives the photons, without the use of a brush and without the use of a permanent magnet.

### CROSS-REFERENCE TO RELATED APPLICATIONS

This application is a continuation of PCT international Patent Application No. PCT/US2024/047630, filed on Sep. 20, 2024, which claims priority to U.S. Provisional Application No. 63/540,154, filed on Sep. 25, 2023, both of which are incorporated by reference herein.

### BACKGROUND

The present disclosure generally pertains to generators and more particularly to a photonically powered electromagnetic generator.

Traditional electric motors and generators typically have either brushes or permanent magnets. For the brush configuration, stationary conductive brushes contact against commutators spinning with a rotating rotor. However, conventional brushes lack durability due to friction and are not well suited for high-speed rotation. The mechanical brushes limit the maximum reachable speed to less than 20,000 rpm, as mechanical wear of the brushes increases significantly. The addition of the mechanical brush and an associated slip ring also undesirably increase the traditional motor stack length, leading to reduced power density.

Permanent magnets are conventionally used for brushless motors or generators. For example, it is known to employ a high-speed electric drive, with a rare-earth permanent magnet motor (e.g., neodymium, dysprosium, and samarium), to actuate propellors for aircraft and drones. However, more complex control circuitry is required to operate a brushless motor or generator. Despite the recent advances in rare-earth permanent magnet motor design and control techniques, challenges still remain such as the shortages and supply chain problems of obtaining these scarce materials. Permanent magnets are also expensive and heavy. In addition, the magnetic field from the permanent magnets cannot be controlled or turned off at will, which may lead to a system failure in fault conditions.

### SUMMARY

In accordance with the present invention, a photonically powered electromagnetic generator is provided. In another aspect, a generator includes a photon source configured to emit photons, a photovoltaic cell configured to receive the photons, a rotor including a yoke and wire windings, a stator surrounding the rotor, and the rotor being configured to create electromagnetism due to its receipt of electricity from the photovoltaic cell when the photovoltaic cell receives the photons, without the use of a brush and without the use of a permanent magnet. A further aspect of a generator includes a photovoltaic receiver, a laser or LED light source emitting light to the photovoltaic receiver, a rotor electrically connected to the photovoltaic receiver, a stator surrounding the rotor, the rotor creating electromagnetism and rotating within the stator when the photovoltaic receiver sends electricity to the rotor, and the electromagnetism ceasing substantially simultaneously when the light ceases to be sent to the photovoltaic receiver. Yet another aspect employs a method of generating electricity including emitting photons at a photovoltaic cell, creating input electricity from the photovoltaic cell, sending the electricity from the photovoltaic cell to wire windings of a rotor, the rotor not having brushes and not having a permanent magnet, rotating the rotor, transmitting magnetic flux from the rotor to a stator, and generating output electricity from the stator.

In an aspect of the present generator, integrated optical power transfer and position estimation is employed in a high-speed electric drive. A further aspect of an actuator includes an optical power source, a photonic-to-electrical power converter, a stator and a movable core. In another aspect, an actuator includes a laser, a photovoltaic cell, a stator and a rotor, with the laser being stationary and sending a laser beam to the photovoltaic cell mounted on the rotor, wherein the solar cell sends an electrical current through wire windings on the rotor in response to receiving the laser beam. A further aspect provides an actuator including a light source used for both a power transfer to an electromagnetic core and for position sensing of the core. In yet another aspect, an electric motor includes a stationary stator, having wire windings, surrounding a rotor, which also has wire windings, a laser sends photonic power through an optical fiber to a spaced apart photovoltaic cell which is affixed adjacent to a central end of the stator, and the photovoltaic cell generates electromagnetic power through the wire windings to rotate the rotor within the stator; the electric motor does not use permanent magnets and does not use brushes.

A method of using an actuator includes emitting photonic energy to a photovoltaic cell within the actuator, converting the photonic energy to electrical current within the actuator, creating electromagnetism within the actuator in response to the electrical current, and moving a metallic core relative to a surrounding stator due to the electromagnetism. A further method additionally includes optically sensing a position of the core relative to the stator by a common laser which also emits the photonic energy to the photovoltaic cell. Another method includes sending photonic power through an optical fiber and across a gap between a stator and a rotor, creating electromagnetic power through wire windings attached to the rotor in response to the photonic power, and rotating the rotor within the stator without a permanent magnet and without a brush.

An embodiment of the present apparatus includes a rare-earth permanent magnet-free, high-speed electric drive leveraging optical (i.e., high-power laser beam) power transfer with a vertical multijunction (VMJ) solar cell and a high-power solid-state laser diode, which are not reliant on rare-earth materials. The optical power transfer system wirelessly provides the electrical power for variable rotor magnetic field generation to replace the permanent magnet and mechanical brushes. This optical power transfer can also be integrated with the existing optical encoder for rotor position estimation and closed-loop control.

The present apparatus is advantageous over traditional devices since the present apparatus beneficially does not require expensive and heavy permanent magnets while also being free to non-durable and rotational speed-limiting brushes. This allows a rotor of the present actuator to spin at speeds greater than 20,000 RPM and even more preferably, greater than 100,000 RPM. Moreover, the present actuator preferably uses a solid-state laser diode with a power of at least 60 KW, yet is expected to be very safe to use since it should not exhibit traditional electrical short circuit failures, and the present apparatus provides automatic switching off of the laser which will immediately cause a cessation of electrical energy and magnetic flux within the motor in the event of a fault.

Another advantage of the present actuator is its compact integration, wherein the optical power transfer component (for example, the laser source and the VMJ PV cell) and rotor position sensor can be integrated to replace bulky mechanical brushes and conventional encoders. Yet another benefit is the long life and durability of the present actuator since there is no brush to wear out. Another notable feature is that the present photonic powered apparatus achieves variable flux operation without additional power electronics in the rotor.

A reduction in weight, size, part cost and manufacturing complexity is also expected since there is no traditional brush, encoder, additional power electronics, and a heavy rare earth magnet. The present actuator is ideally suited for use as a traction motor in electrically powered automotive vehicles or to move components in an aircraft, given the light weight, high RPM speed and durability of the apparatus. Additional advantages and features will be disclosed in the following description and appended claims, taken in conjunction with the accompanying drawings.

### BRIEF DESCRIPTION OF THE DRAWINGS

FIG. 1 is a diagrammatic side view showing the present generator in a vehicle embodiment;

FIG. 2 is a diagrammatic view showing the present generator in a turbine embodiment;

FIG. 3 is a side elevation view showing the present generator employing an LED photon source;

FIG. 4 is a side elevation view showing the present generator employing a laser photon source;

FIG. 5 is a diagrammatic side view showing the present generator;

FIG. 6 is an enlarged and diagrammatic side view showing a rotor of the present generator;

FIG. 7 is a diagrammatic end view showing the present generator;

FIG. 8 is a diagrammatic end view showing a traditional generator;

FIG. 9 is a fragmentary magnetic flux diagram of the traditional generator of FIG. 8;

FIG. 10 is a graph showing magnitude versus time for the traditional generator of FIG. 8;

FIG. 11 is a fragmentary magnetic flux diagram of the present generator of FIG. 7;

FIG. 12 is a graph showing magnitude versus time for the present generator of FIG. 7;

FIG. 13 is a graph showing voltage versus time for the present generator;

FIG. 14 is an electrical diagram of the present generator of FIG. 5;

FIG. 15 is a diagrammatic side view showing the present generator including a position sensing system;

FIG. 16 is a diagrammatic end view showing a light pattern relative to a photovoltaic cell of the present generator of FIG. 15;

FIG. 17 is an electrical diagram of the present generator of FIG. 15; and

FIG. 18 is a diagrammatic end view of a DC embodiment of the present generator.

### DETAILED DESCRIPTION

A high-efficiency and high specific power density electric drive system (i.e., variable-frequency drive, electric motor, and controller) is an enabling technology for a direct emission-free electric/hybrid unmanned aircraft system (UAS) and electric vertical take-off and landing (eVTOL) drone. Increasing the maximum speed of the electric drive system is the most effective way of reducing the total system mass and improving the fuel efficiency as it shrinks the size of the stator and rotor cores of electric motors as well as passive components in variable-frequency drives (VSDs). Ideally, the high-speed is >60,000 rpm.

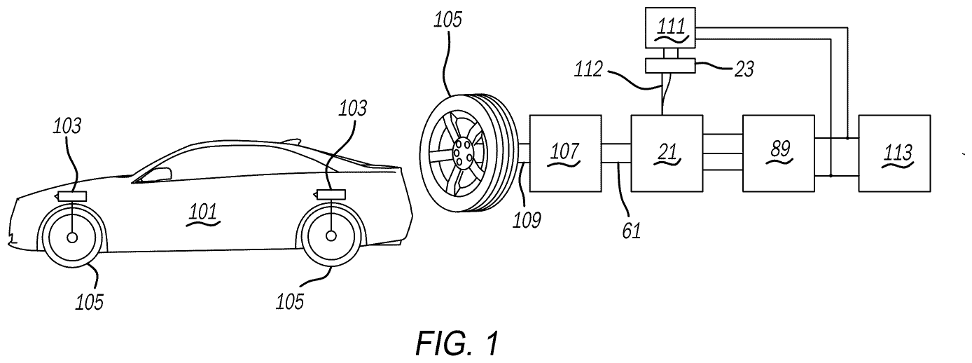

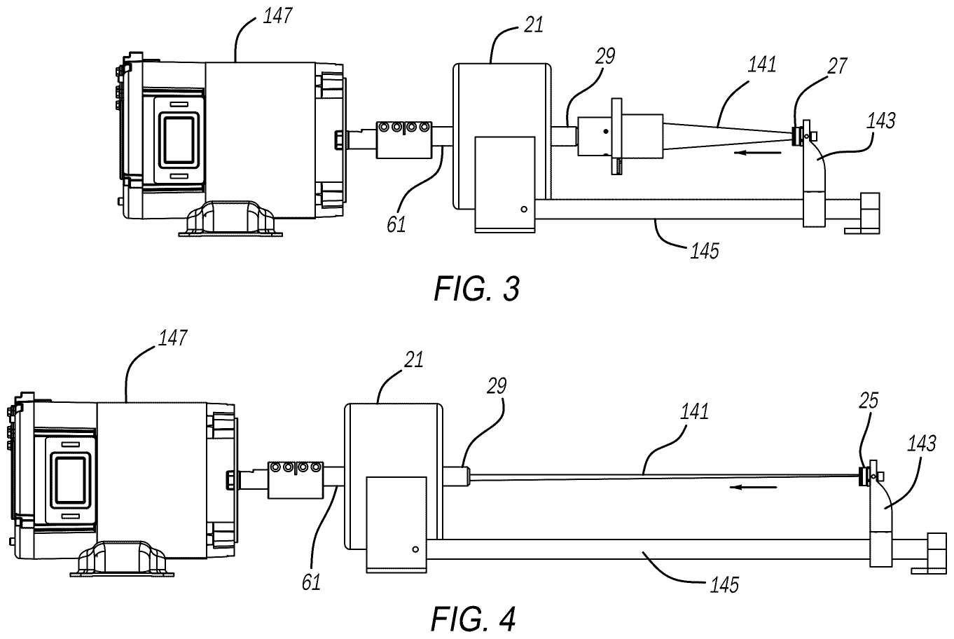

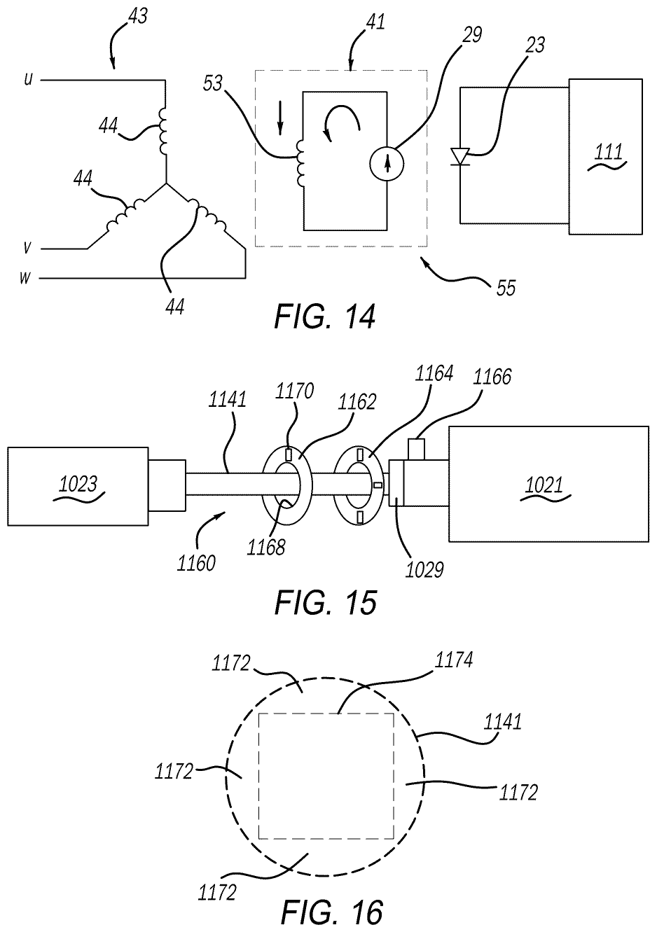

The present apparatus is a wound-field synchronous motor (WFSM) based electric drive or generator 21 with an optical power transfer system (i.e. beam power transfer), enabling brushless and rare-earth magnet-free high-speed electric drive operation as shown in FIGS. 1-7, 13 and 14. The optical power transfer system includes a photon or light source 23, such as a high-power laser diode 25 (see FIG. 4) or a light emitting diode (LED) 27 (see FIG. 3). The optical power transfer system further includes a vertical multi-junction (VMJ) solar or photovoltaic cell 29 for the rotor magnetic field generation. The rotor field winding will be optimally designed to achieve maximum power point of the VMJ solar cell 29 at the rated condition for achieving the maximum efficiency.

The present electric drive or generator 21 includes a rotatable rotor 41 surrounded by a generally cylindrical stator 43. Stator 43 has wire windings 44 therein. Rotor 41 has a cylindrical yoke 45 from which radially project a radial segment 47 of each tooth 49. An outer segment 51 of each tooth 49 laterally extends from an end of radial segment 47 to define a generally T-shape with a curved outermost surface adjacent to but spaced from an inner diameter of stator 43. Wires 53 are wrapped around radial segment 47 of each tooth 49, and are connected to an electrical circuit 55 which includes an electrical connection to photovoltaic cell 23.

An output shaft 61 is centrally coupled to rotor yoke 45, both of which rotate about centerline axis 63. Rotor 41 and stator 43 are located within an external drive housing 65. Bearings 66 are also located between output shaft 61 and the adjacent portions of external drive housing 65, or mounting brackets inwardly extending therefrom. Furthermore, photon source 23 and photovoltaic cell 29 are located within an external optics housing 67, removably attached to external drive housing 65.

FIG. 1 illustrates a first exemplary implementation of the present generator 21. This apparatus employs a moving vehicle, such as an automotive vehicle 101 including one or multiple driving electric motor actuators 103, each of which includes generator 21. Rotating drive wheels 105 are coupled to an optional reduction gear box 107 via an axle 109. Gear box 107 rotates shaft 61 of generator 21, which serves to rotate the rotor within the stator, while a power supply 111 powers photonic light source 23 to emit photons 112 received by the photovoltaic sensor connected to the rotor windings. This causes electromagnetism to flow between the spinning rotor and the stationary stator, which generates electricity transmitted to an AC-DC converter 89 for storage in a vehicle-mounted battery 113 and/or for vehicular consumption. Alternately, the vehicle may be an aircraft such as a UAV drone, a manned helicopter or a manned airplane, with a rotating blades overhead or in a jet engine.

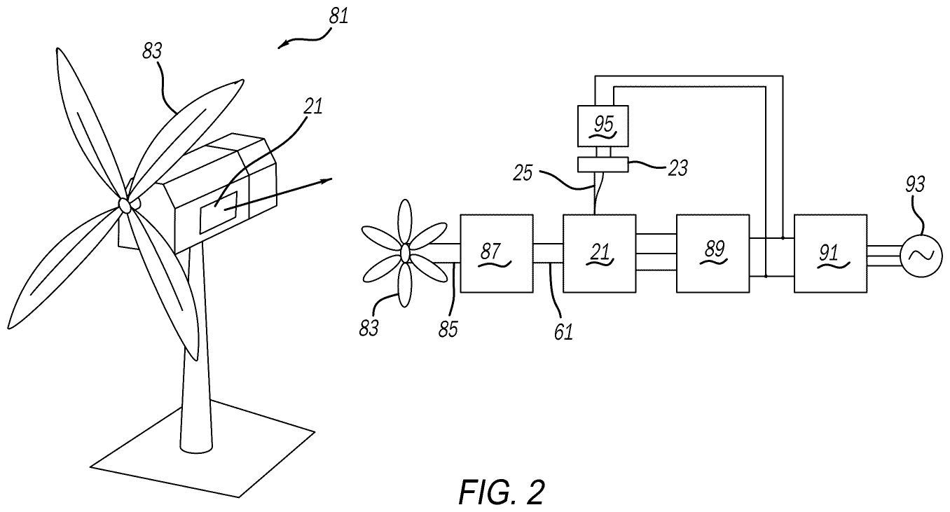

FIG. 2 illustrates a second exemplary implementation of the present generator 21. This apparatus employs a turbine 81, such as the illustrated wind turbine with blades 83 rotated by the wind, which rotates an input hub 85 coupled to an optional reduction gear box 87, that in turn, rotates shaft 61. Moreover, shaft 61 operably rotates the rotor of generator 21 while photon source 23 emits photonic light 25 at the photovoltaic cell connected to the rotor. The blade rotation of rotor plus the optically induced electromagnetism between the rotor and stator, generate electricity to Alternating Current (AC)-Direct Current (DC) and DC-AC converters, 89 and 91 respectively, and then to an alternator 93 and/or other circuitry. A power supply 95 is connected to and electrically powers photon source 23. Alternately, turbine 81 may instead include a hydroelectric (e.g., dam), tidal, steam or hydrocarbon driven blades or a high-speed compressor, instead of the wind turbine blades shown. Optionally, the rotor shaft may include radially extending fan formations that serve to air cool the photovoltaic cell.

Turning now to the testing system configuration of FIG. 3, LED photon source 27 emits photonic light 141 at photovoltaic cell or receiver 29. An exemplary photovoltaic cell can be obtained from Azur Space Solar Power GmBH of Heilbronn, Germany, as model type concentrator triple junction solar cell 3C44, although other cells may be used. LED 27 is mounted to an upstanding bracket 143 which is slidingly coupled to an elongated track 145 to provide longitudinal adjustment. A rotor and stator are provided within generator 21 as previously discussed herein, and output shaft 61 of rotor rotates an input shaft of a prime mover 147 coupled thereto, such as a turbine, engine or blade assembly.

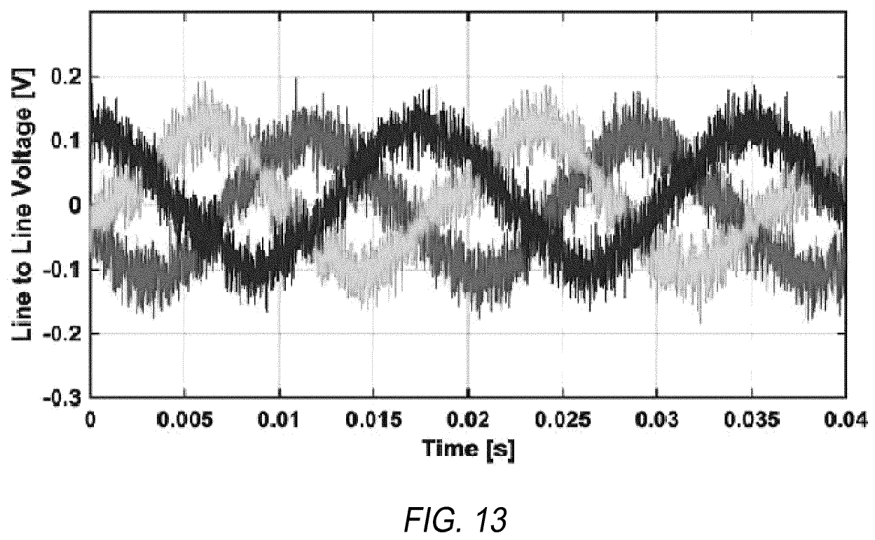

FIG. 4 shows a similar testing system configuration but employing laser diode 25, preferably having a 976 nm wavelength and about 40-100 W of power. An external cooling fan or fluid cooling tubes may be optionally provided for the stator. A measured back-EMF at 400 rpm and P_{field}=40 mW is illustrated in FIG. 13. Exemplary and nonlimiting performance of the FIGS. 3 and 4 embodiments is expected to achieve at least 40,000 rpm rotor output, less than 50 W of filed winding power consumption, a power density greater than 50 KW/L, a specific power density of at least 6 kW/kg, galvanic isolation, system efficiency greater than 95%, and with low EMI noise operation.

Furthermore, the expected efficiency and power estimation of the present WFSM generator 21, with the optical power transfer system, has an estimated total system efficiency that exceeds 97% with 10 kW output power at 100,000 rpm. The estimated specific power density also exceeds 12 kW/kg. Due to the increased motor speed, the required field current reduces proportionally and the estimated power loss at the rotor field winding conduction loss will be less than 2 W. Considering typical laser diode electrical to optical power efficiency of 50% and the VMJ cell efficiency of 20%, the total power consumption of the optical power transfer system will be less than 20 W, which is only 0.2% of the total system power rating of 10 KW.

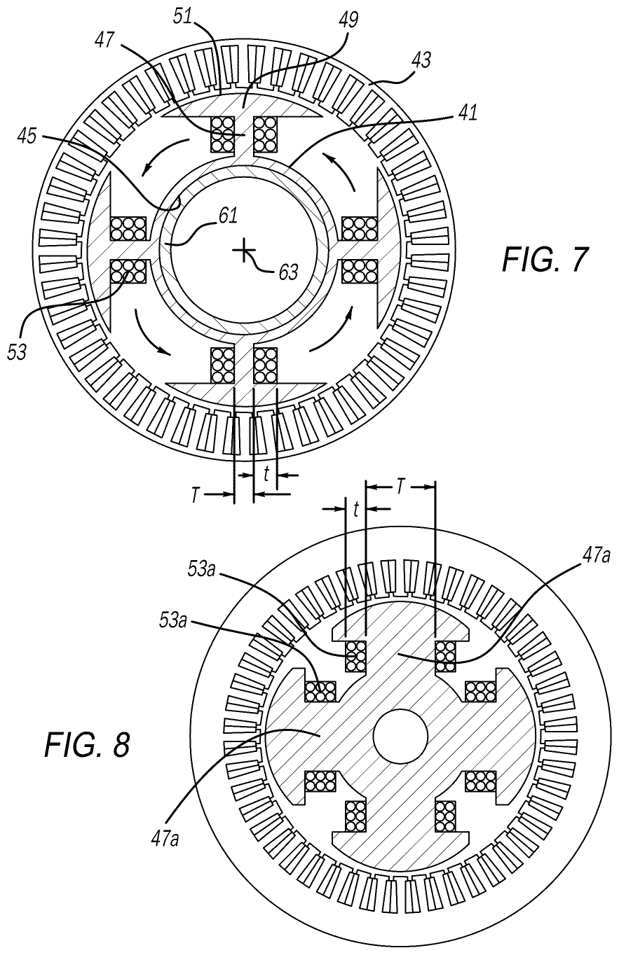

The tooth design and associated magnetic flux density of the present WFSG generator versus a conventional generator can be observed by comparing FIGS. 7-12. FIGS. 8, 9 and 10 show the conventional rotor design where the lateral thickness T of each radial tooth segment 47a is at least four times greater than an adjacent thickness t of wire winding 53a on each side thereof. This thick traditional rotor design disadvantageously leads to a total generator weight of approximately 19.5 kg, a maximum power of 40 kW, a maximum rotor speed of 8,000 rpm, a field current of 10 Amps, a stator yoke thickness of 25 mm, a rotor tooth width thickness of 50 mm at radial segment 47a, and a cylindrical rotor yoke thickness of 25 mm.

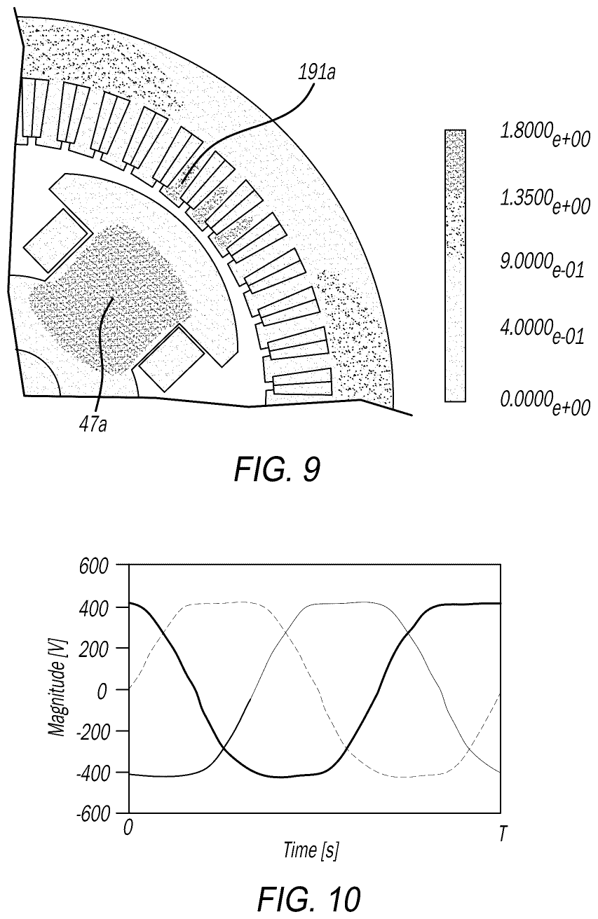

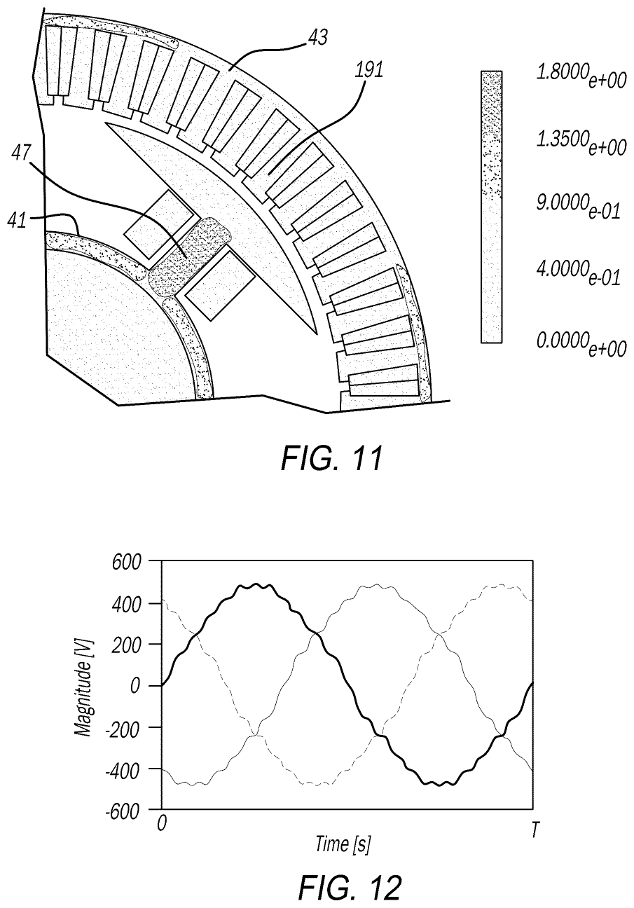

In contrast, the present rotor has a lateral thickness T of each radial tooth segment 47 which is less than an adjacent thickness t of wire winding 53 on each side thereof, per FIG. 8. The thin and high-speed present rotor design beneficially leads to a total generator weight of approximately 9.3 kg, a maximum power of 40 KW, a maximum rotor speed of 40,000 rpm, a field current of 2 Amps, a stator yoke thickness of 5 mm, a rotor tooth width thickness of 10 mm at radial segment 47, and a cylindrical rotor yoke 41 thickness of 5 mm. Also, a radial length of the radially extending segment of a tooth of the rotor is greater than a width of the segment. The high magnetic flux density of the conventional rotor and stator is extremely localized in the radial tooth segment 47a and in inner projections 191a of the stator, can be seen in FIG. 9, with a back-EMF at 8 krpm shown in FIG. 10. In contrast and as is shown in FIG. 11, a much more uniform and greater magnetic flux density is present in each tooth radial segment 47 and the adjacent cylindrical rotor yoke 41 of the present generator 21, with minimal concentrated flux density in inner projections 191 of stator 43. Therefore, a magnetic flux density of the stator adjacent to the rotor tooth is less than the magnetic flux density anywhere in the rotor tooth. The present back-EMF at 40 krpm is illustrated in FIG. 12.

An advantage of using the present optical power transfer in the high-speed electric drive is the ability to achieve both mechanical and electrical isolation between the power source and the electric motor regardless of the drive operating speed. Since the VMJ solar cell produces a dc power (dc voltage and current), no additional power conversion circuit is required, and the solar cell terminals can be directly connected to the rotor winding. In contrast, conventional inductive or capacitive wireless power transfer techniques require two stages of power conversion (DC-AC and AC-DC) to transmit the power through an airgap with time varying magnetic or electric field. The traditional rotating magnetic or electric field needs to be synchronized with the motor operating speed, which requires advanced frequency tracking system leading to compromised stability and reliability of the drive system. However, the present optical power transfer system has the VMJ solar cell at the center of the rotor shaft directly receiving the precisely controlled and consistent laser beam for DC power generation. The present optical power transfer mechanically and electrically decouple the motor operation with the electrical power transmission without any power conversion circuits nor frequency tracking system, beneficially leading to stable and reliable high-speed electric drive operation.

Another notable benefit of the present optical power transfer in the present high-speed electric drive is the elimination of mechanical brushes for high-speed drive operation. The presence of the mechanical brush in the conventional WFSM has been the bottleneck for increasing the motor operating speed. However, the elimination of the mechanical brushes in the present apparatus improves the reliability and the maximum operating speed, thereby leading to high power density. By way of nonlimiting example, the present WFSM with the optical power transfer will reach at least 100,000 rpm for the specific power density target of >12 kW/kg.

A third benefit of the present WFSM generator with its optical power transfer is the minimum power losses in the rotor winding and maximized efficiency. The maximum transferrable power through the laser is limited by the maximum laser power, VMJ solar cell thermal limit, and maximum voltage/current limit of the solar cell. The specification of the target VMJ solar cell is summarized in Table 1 where the maximum power is limited by 2.16 W.

TABLE 1
Electrical Characteristics of VMJ Solar Cell.

| Optical Power [W] | 1 | 3 | 5 | 10 |
|---|---|---|---|---|
| Max. Power [W] | 0.181 | 0.643 | 1.08 | 2.16 |
| Max. Voltage [V] | 28.3 | 30.6 | 30.9 | 31.3 |
| Max. Current [mA] | 6.4 | 21.0 | 35.0 | 69.0 |
| Efficiency [%] | 18.1 | 21.4 | 21.6 | 21.6 |

When the present electric motor is designed to operate at high-speed with high number of winding turns (>500 turns per rotor pole), the 2.16 W of power optically transferred to the rotor can generate sufficient rotor magnetic flux for high-power operation. Considering typical laser diode, electrical-to-optical power efficiency of 50% and the VMJ cell efficiency of 20%, the total power consumption of the optical power transfer system will be less than 20 W, which is only 0.2% of the total system power rating of 10 KW.

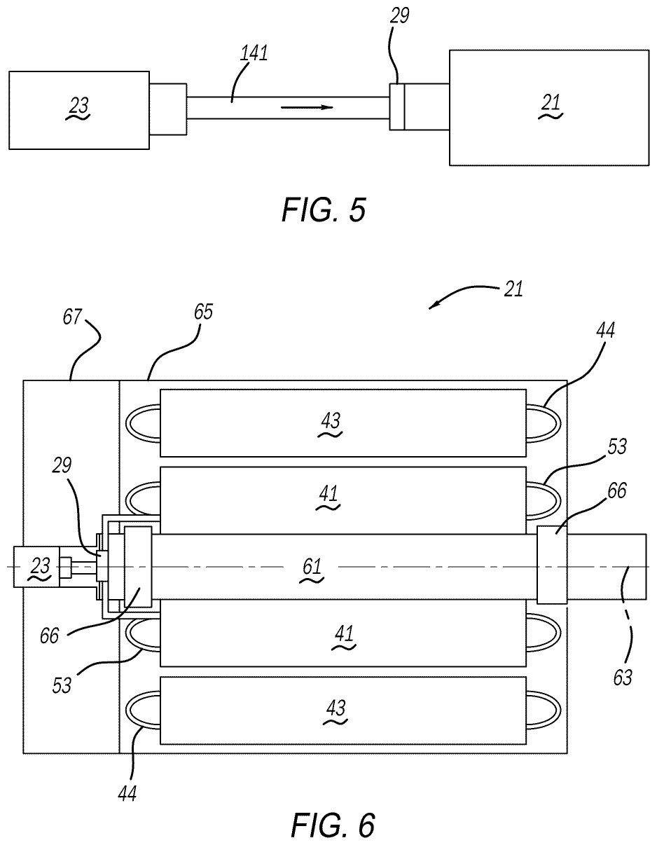

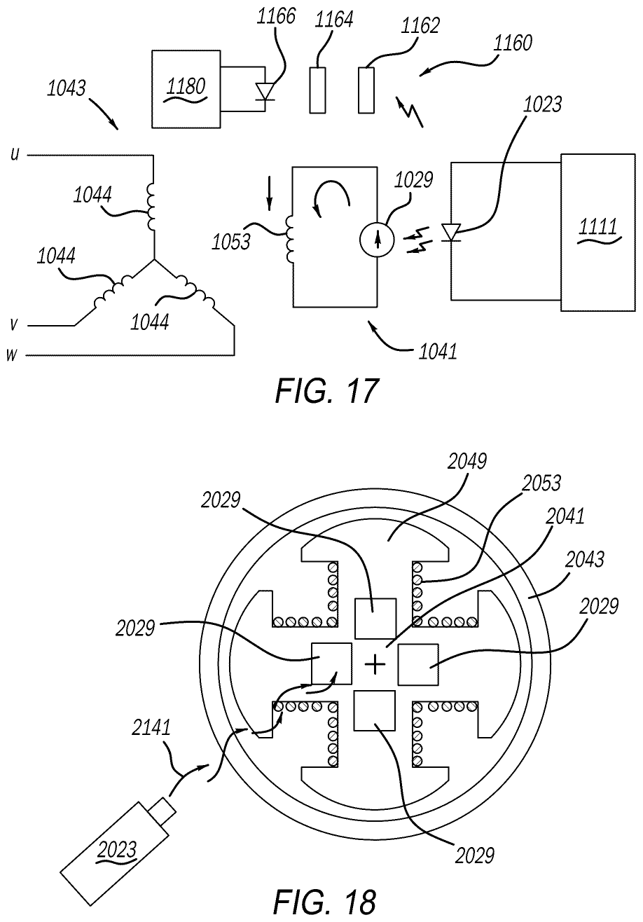

Another embodiment is shown in FIGS. 15-17. In addition to the optical power transfer for rotor magnetic flux generation of the previously discussed embodiment of FIGS. 5-7, the high-power laser beam can also be utilized for rotor position estimation. This exemplary embodiment apparatus includes a generator 1021 having a rotor 1041 and a stator 1043. A photonic light source 1023 emits a photonic light beam 1141 to a photovoltaic cell receiver 1029 electrically connected to windings 1053 of rotor 1041. Electromagnetism is created and transferred between the rotor windings 1053 and stator windings 1044, as with the previously discussed embodiment.

However, a position detector system 1160 includes a stationary disk or mask 1162, a longitudinally offset rotational disk or mask 1164 and a position photosensor 1166. Each disk has a central aperture 1168 through which the primary portion of photonic light 1141 emitted by laser or LED source 1023 travels before being received by photovoltaic cell 1029. Stationary disk 1168 is mounted to a bracket or the like internally projecting from a surrounding housing. Stationary disk preferably has a single elongated slot or opening 1170 therein, and rotational disk 1164 preferably has multiple, such as four, equally spaced apart slots or openings therein. Rotational disk 1164 is coupled for rotation with the central rotor shaft.

Outer partial portions 1172 of photonic light 1141, outside a rectangular periphery 1174 of photovoltaic cell 1029, are aligned with disks 1162 and 1164 such that the outer light photons 1172 transmit through the slots 1170 therein. In other words, for the maximum optical power transfer, the laser beam diameter is sized to overfill the square solar cell, and the residual laser beam can be directed through stationary, rotary disks (i.e. code wheel), and the photosensor. This transmitted outer or overfilled light 1172 received by photosensor 1166, depending on the positional alignment of slots 1170 between the disks, is then sent as signals to a programmable controller 1180. Controller 1180 includes software instructions stored in non-transient RAM or ROM memory, and operated on a microprocessor, which counts the aligned light signals received and determines a rotational position of the rotor.

Optionally, a collimator or other optics may be employed for the outer light portions. Moreover, two types of typical optical encoder structures may be employed where light produced from the photon source emitter is either transmitted or reflected from the code wheel disk. Therefore, the proposed system integrates both optical power transfer with rotor position.

Finally, FIG. 18 illustrates a Direct Current generator of the present apparatus including a rotor 2041 and a stator 2043 similar, which may or may not include the optical position detection system described hereinabove. A laser diode or LED phonic light source 2023 sequentially emits a photonic light beam 2141 to an aligned one of multiple photovoltaic cells or receivers 2029 as the cells are rotated. Photovoltaic cells 2029 are mounted for rotation with rotor 2041, such as each cell being located on each tooth 2049, and electrically connected to wire windings 2053 thereon.

While various embodiments of the present sensor system have been disclosed, it should be appreciated that other variations may be made. For example, alternate electrical circuits and electronic components may be used although some of the present benefits may not be realized. Furthermore, the quantity of teeth and the tooth shape may vary from that disclosed, although some of the desired benefits may not be obtained due to the differences. As another example, various lenses, optical fibers, beam splitters, optical switches and the like may be employed between the photon source and the photovoltaic cell. The features of any of the embodiments may be mixed and matched in an interchangeable manner with any of the other embodiments disclosed herein. Various changes and modifications are not to be regarded as a departure from the spirit or the scope of the present invention.

The invention claimed is:

1. A generator comprising:
a photon source configured to emit photons;
a photovoltaic cell configured to receive the photons;
a rotor including a yoke and wire windings;
a stator surrounding the rotor; and
the rotor being configured to create electromagnetism due to its receipt of electricity from the photovoltaic cell when the photovoltaic cell receives the photons, without the use of a brush and without the use of a permanent magnet.

2. The generator of claim 1, further comprising an electric actuator connected to the stator by an electrical circuit, the rotor and stator creating Alternating Current electricity which is transmitted to the electric actuator, and the photon source and the photovoltaic cell are located within an external optics housing attached to an external drive housing within which the rotor and the stator are located.

3. The generator of claim 1, further comprising an electric actuator connected to the stator by an electrical circuit, the photovoltaic cell including multiple photovoltaic cells mounted to and rotating with the rotor, and the rotor and stator creating Direct Current electricity which is transmitted to the electric actuator.

4. The generator of claim 1, wherein a radial length of a radially extending segment of a tooth of the rotor is greater than a width of the segment, and a width of the wire windings on each side of the radially extending segment is greater than the width of the segment, and a magnetic flux density of the stator adjacent to the tooth is less than the magnetic flux density anywhere in the tooth.

5. The generator of claim 1, wherein the photovoltaic cell is a vertical multi-junction cell, located adjacent to an axis of the rotor, and the photon source emits the photons along the axis of the rotor.

6. The generator of claim 1, wherein:
the photon source is an LED spaced away from the photovoltaic cell; and
all magnetic flux ceases within the stator and the rotor when the LED is deactivated.

7. The generator of claim 1, wherein:
the photon source is a laser spaced away from the photovoltaic cell; and
all magnetic flux ceases within the stator and the rotor when the laser is deactivated.

8. The generator of claim 1, wherein the photon source is a laser diode which is coupled to the photovoltaic cell by an optical fiber through which the photons are transmitted, and the rotor spins greater than 100,000 RPM.

9. The generator of claim 1, further comprising a photosensor and a slotted position indicator, the position indicator rotating with the rotor, the photon source emitting some of the photons through slots in the position indicator, and the photosensor sensing the photons passing through the position indicator to assist in determining a rotational position of the rotor.

10. The generator of claim 1, further comprising a mobile vehicle including an electric motor and a drive output, electricity from the stator being transmitted to the electric motor which rotates the drive output.

11. The generator of claim 1, further comprising turbine blades rotatable about a central shaft which is coupled to a gear box, an output shaft from the gear box being configured to rotate the rotor, and the stator operable to generate electricity due to the photovoltaic cell creating electromagnetism from the windings of the rotor when the rotor is rotated.

12. A generator comprising:
a photovoltaic receiver;
a laser or LED light source emitting light to the photovoltaic receiver;
a rotor electrically connected to the photovoltaic receiver;
a stator surrounding the rotor;
the light source and the photovoltaic receiver being located within an optics housing attached to a drive housing containing the rotor and the stator;
the rotor creating electromagnetism and rotating within the stator when the photovoltaic receiver sends electricity to the rotor, without the use of a brush and without the use of a permanent magnet; and
the electromagnetism ceasing substantially simultaneously when the light ceases to be sent to the photovoltaic receiver.

13. The generator of claim 12, further comprising an electric actuator connected to the stator by an electrical circuit, the rotor and stator creating Alternating Current electricity which is transmitted to the electric actuator.

14. The generator of claim 12, further comprising an electric actuator connected to the stator by an electrical circuit, the photovoltaic receiver including multiple photovoltaic cells mounted to and rotating with the rotor, and the rotor and stator creating Direct Current electricity which is transmitted to the electric actuator.

15. The generator of claim 12, wherein a radial length of a radially extending segment of a tooth of the rotor is greater than a width of the segment, and a width of the wire windings on each side of the radially extending segment is greater than the width of the segment, and a magnetic flux density of the stator adjacent to the tooth is less than the magnetic flux density anywhere in the tooth.

16. The generator of claim 12, wherein the photovoltaic receiver is a vertical multi-junction cell, located adjacent to an axis of the rotor.

17. The generator of claim 12, wherein the light source is a laser diode which is coupled to the photovoltaic receiver by an optical fiber through which the light is transmitted.

18. The generator of claim 12, further comprising a light sensor and a slotted position indicator, the position indicator rotating with the rotor, the same light source that sends the light to the photovoltaic receiver also sending some of the light through openings in the position indicator, and the light sensor sensing the light passing through the position indicator to assist in determining a rotational position of the rotor.

19. The generator of claim 12, wherein:
the rotor rotates at a speed of at least 40,000 rpm;
the stator generates at least 40 KW of electricity;
the stator has a field current of no more than 2 Amps; and
a total weight of the rotor and the stator are less than 10 kg.

20. A generator comprising:
a photon source configured to emit photons;
a photovoltaic cell configured to receive at least a majority of the photons;
a rotor including teeth and wire windings, the wire windings being electrically connected to the photovoltaic cell;
a stator surrounding the rotor;
a photosensor;
the rotor rotating within the stator when the photovoltaic cell sends electricity to the rotor, without the use of a brush and without the use of a permanent magnet; and
a slotted position indicator, the position indicator rotating with the rotor, the photon source emitting some of the photons through at least one slot in the position indicator, and the photosensor sensing the photons passing through the position indicator to assist in determining a rotational position of the rotor.

21. The generator of claim 20, wherein:
the photon source is a laser or an LED; and
the rotor being configured to create electromagnetism due to its receipt of electricity from the photovoltaic cell when the photovoltaic cell receives the photons, without the use of a brush and without the use of a permanent magnet.

22. The generator of claim 20, further comprising a mobile vehicle including an electric motor and a drive output, electricity from the stator being transmitted to the electric motor which rotates the drive output.

23. The generator of claim 20, further comprising turbine blades rotatable about a central shaft which is coupled to a gear box, an output shaft from the gear box being configured to rotate the rotor, and the stator operable to generate electricity due to the photovoltaic cell creating electromagnetism from the windings of the rotor when the rotor is rotated.
